(19) United States
(12) Patent Application Publication
(10) Pub. No.: US 2026/0362098 A1
(43) Pub. Date: Nov. 12, 2026

(54) METHODS, ARCHITECTURES, APPARATUSES, AND SYSTEMS FOR SENSING DATA COLLECTION, PROCESSING, AND VALIDATION

(71) Applicant: InterDigital Patent Holdings, Inc., Wilmington, DE (US)

(72) Inventors: Zhibi Wang, Woodridge, IL (US); Jung Je Son, Warrington, PA (US); Magurawalage Chathura Madhusanka Sarathchandra, London (GB); Sebastian Robitzsch, London (GB); Laksh Bhatia, London (GB); Muhammad Awais Jadoon, London (GB); Filipe Conceicao, London (GB)

(21) Appl. No.: 19/202,974

(22) Filed: May 8, 2025

(51) Int. Cl. H04W 4/38; H04W 8/22; H04W 12/02

(52) U.S. Cl. CPC H04W 4/38; H04W 8/22; H04W 12/02

(57) ABSTRACT

Procedures, methods, architectures, apparatuses, systems, devices, and computer program products are provided for the protection of private information collected by a wireless transmit/receive unit (WTRU). The WTRU may transmit to a wireless network its capability information for sensing measurement data collection and privacy processing. The WTRU may receive, from the wireless network, data collection template information, which may indicate the types of data needed and how the data is to be organized, and privacy policy information, which may indicate privacy protection measures to be taken for various types of data collected. The WTRU may then collect sensing measurement data based on the received data collection template information, process the sensing measurement data based on the received privacy policy information, and transmit, to the wireless network, a sensing data report based on the processed sensing measurement data.

### TECHNICAL FIELD

The present disclosure is generally directed to the fields of communications, software, and encoding/decoding, including, for example, to methods, architectures, apparatuses, and systems related to integrated sensing data collection and processing, and more particularly to collecting sensing data and processing the data for privacy protection by.

### BACKGROUND

Devices, e.g., wireless transmit/receive units (WTRUs) that are communicatively coupled to a wireless network may be configured by the wireless network to collect and process sensing data. During this process, personally identifiable information (PII) or other sensitive or confidential data may be collected by one or more devices.

### SUMMARY

A WTRU may be configured for integrated sensing and communication. For example, a WTRU (e.g., a sensing entity, sometimes referred to as a user device) may perform sensing operations based on requirements transmitted to it by the wireless network. The wireless network may need such information for a variety of tasks in a variety of settings. Despite the voluminous amounts of data that is often gathered, many types of data may need to be kept confidential and private. Accordingly, systems and methods desired for processing the collected data by the WTRU are described.

In accordance with some embodiments of this disclosure, the WTRU may transmit to the wireless network its capability information for sensing measurement data collection and privacy processing. The WTRU may receive, from the wireless network, data collection template information and privacy policy information, collect sensing measurement data based on the data collection template information; process the sensing measurement data based on the privacy policy information; and transmit, to the wireless network, a sensing data report based on the processed sensing measurement data.

In such a method, the sensing measurement data may include one or more data types indicated by the data collection template information. The WTRU may then determine what data to collect and how to organize the collected data based on the data collection template information.

The privacy policy information may indicate the type (or types) of policy protection actions that are to be used for various types of data in the set of collected data. For example, an obfuscation action may be used on some types of data, and an anonymization action may be used on other types of data. Other such data privacy protection measures may include pseudonymization or masking for the processing of the collected sensing measurement data.

Such a method may also include receiving processing configuration information for a processing agent of the WTRU. The processing configuration information may indicate dataset templates that the processing agent of the WTRU is to generate.

In such a method, the data collection template information may be based on the sensing requirements from a sensing service and the capability information for sensing data collection and the privacy processing.

The privacy policy information may be based on sensing requirements from a sensing service, privacy regulation, operator's privacy rules, sensing entity privacy setting, or the capability information for sensing data collection and privacy processing.

The WTRU's processing of the sensing measurement data based on the privacy policy information may include anonymizing or obfuscating personally identifiable information contained in the collected sensing measurement data.

The sensing measurement data may include contextual information associated with one or more data fields of the sensing measurement data. Such contextual information may include one or more of a time, a location, or environmental data such as temperature, humidity, or a weather condition such as rainfall.

The sensing measurement data may be collected from a device that uses a non-third generation partnership project (non-3GPP) protocol.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a reference model of an example wireless network with which a WTRU communicates, in accordance with some embodiments of the disclosure;

FIG. 3 is a diagram depicting an example of a sensing measurement data collection in a pedestrian and/or animal intrusion mode, in accordance with some embodiments of the disclosure;

FIG. 4 is a diagram depicting an example of sensing measurement data collection by a WTRU, in accordance with some embodiments of the disclosure;

FIG. 5 is a flowchart of an illustrative method for communication steps for sensing measurement data collection, processing and reporting, in accordance with some embodiments of the disclosure;

FIG. 6 is a flowchart of an illustrative method performed by a WTRU for sensing measurement data collection, processing and reporting, in accordance with some embodiments of the disclosure; and

FIG. 7 is a flowchart of an illustrative method performed by a wireless network for sensing measurement data collection and processing, in accordance with some embodiments of the disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

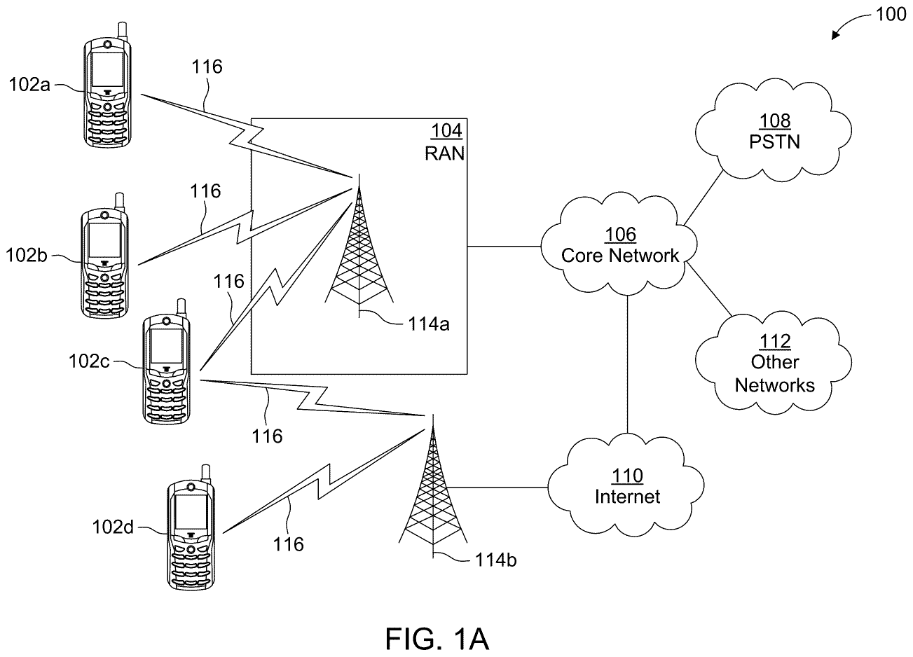

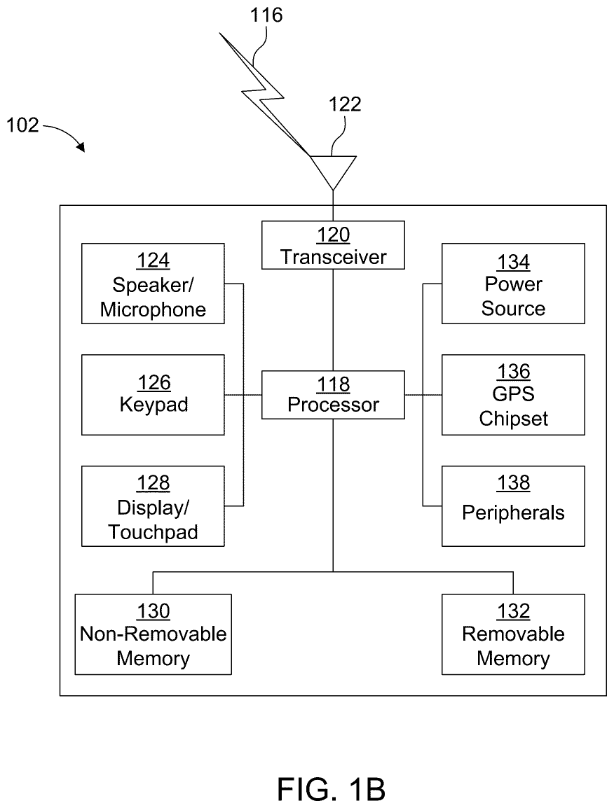

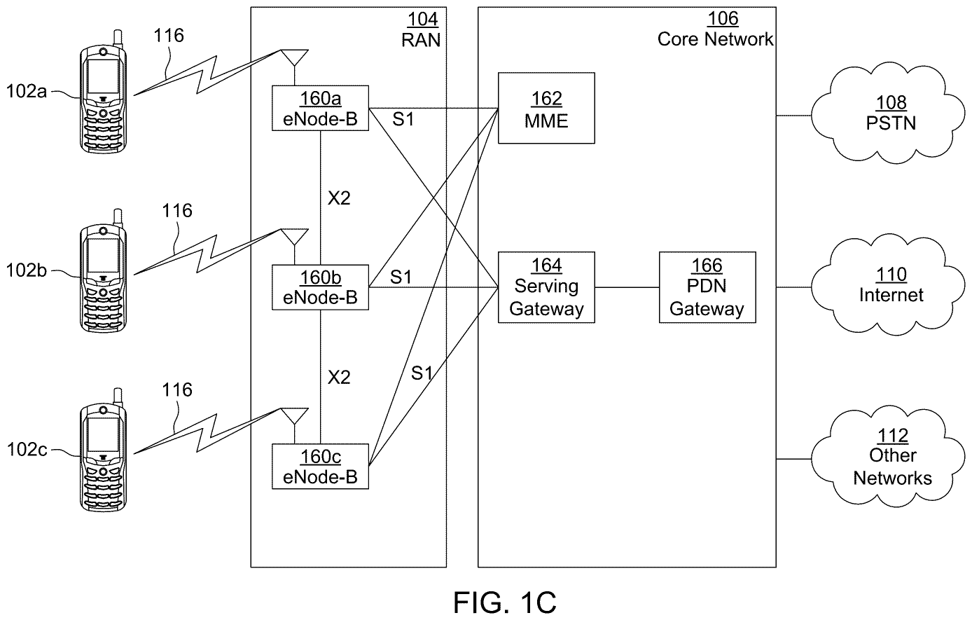

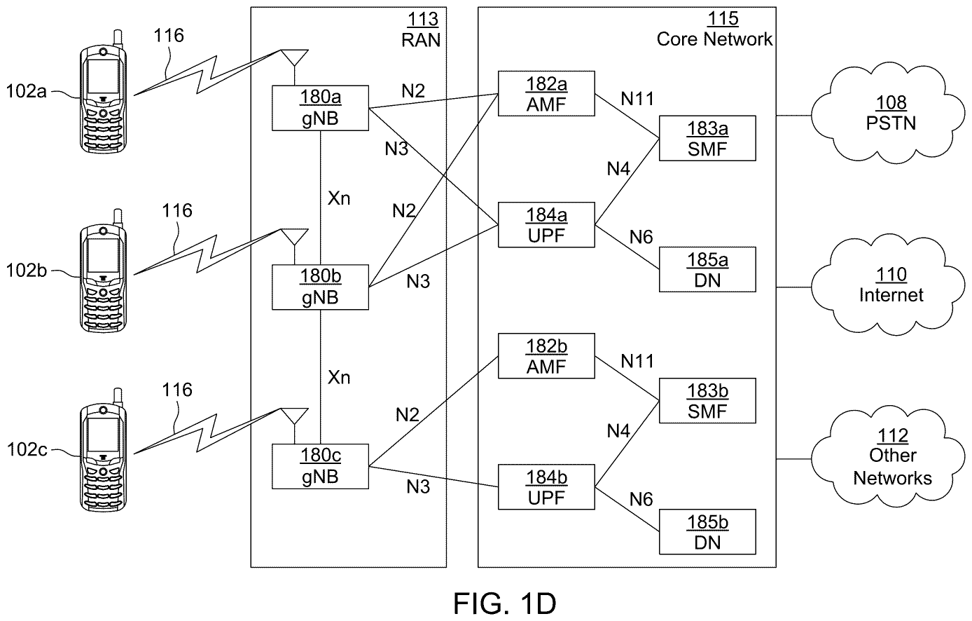

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNB, a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

It will be understood that a wireless network may include any suitable components and devices, including, for example, any of one or more base stations, one or more TRPs, one or more gNBs, one or more WTRUs, any network functions, one or more RANs, one or more application functions, one or more access and mobility management functions (AMFs), any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80×80 configuration. For the 80×80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80×80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards AMFs 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

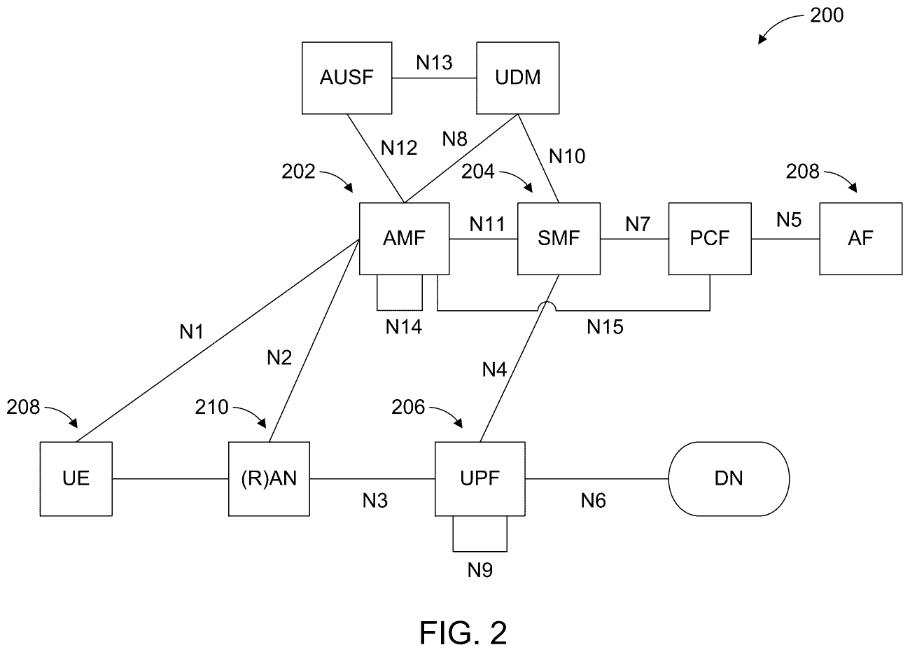

In certain embodiments of the present disclosure, including those described below at least in connection with FIGS. 2-6, the devices, systems, architectures, communication links, apparatuses, and other elements depicted in FIGS. 1A-1D may be used in connection with sensing availability evaluation of sensing entities.

FIG. 2 is a reference model of an example wireless network with which a WTRU communicates, in accordance with certain embodiments.

In accordance with certain embodiments of this disclosure, a reference model of a 5G network, or other suitable network, is shown in FIG. 2 and described as follows. FIG. 2 illustrates an example of a reference model of a network architecture (e.g., a 5G or NextGen network). In certain representative embodiments, AMF 202 (e.g., which may be the same as AMF 182a or 182b) includes the functionalities of registration management, connection management, reachability management, and mobility management. In certain representative embodiments, SMF 204 (e.g., which may be the same as SMF 183a or 183b) includes the functionalities of session management (e.g., session establishment, modification, and release), WTRU IP address allocation, selection, and control of UPFs. In certain representative embodiments, the UPF 206 (e.g., which may be the same as UPF 184a or 184b) includes the functionalities of packet routing, packet forwarding, packet inspection, and traffic usage reporting. In certain representative embodiments, the network architecture includes an application function (AF) 208 and RAN 210.

Integrated sensing may include different potential requirements for specific use cases. Integrated sensing may enhance a 5G system (5GS) such that the 5GS may better provide sensing services addressing different target verticals/applications (e.g., autonomous/assisted driving, vehicle to everything (V2X), unmanned aerial vehicles (UAVs), 3D mapping, smart city, smart home, factories, healthcare, or maritime sector applications).

In integrated sensing applications, there may be a process of collecting sensing measurement data. The sensing measurement data, for example, may be data collected about radio/wireless signals impacted (e.g., reflected, refracted, diffracted) by an object or by an environment of interest for sensing purposes. An example of generating sensing measurement data may be deriving sensing results from processing sensing measurement data. There may also be an area defined for sensing, e.g., a sensing service area (SSA) location, which may be an area or location (with or without at least one obstacle) in which the SSA can provide sensing service with target quality. Still further, for example, non-3GPP (N3GPP) entities are considered; sensing measurement data related to N3GPP entities may be considered as transparent to 5GS, such that the corresponding data may be communicated using a standard protocol to an interface defined by the 5GS. One use case for integrated sensing is object detection for a pedestrian/animal intrusion detection on a highway. Other N3GPP entities may be considered as well, and their sensing data may be considered as transparent to 5GS such that the data is communicated using a standard protocol to an interface defined by the 5GS.

One of use case for integrated sensing is object detection, for example pedestrian/animal intrusion detection on a highway or intruder detection in surroundings of smart home.

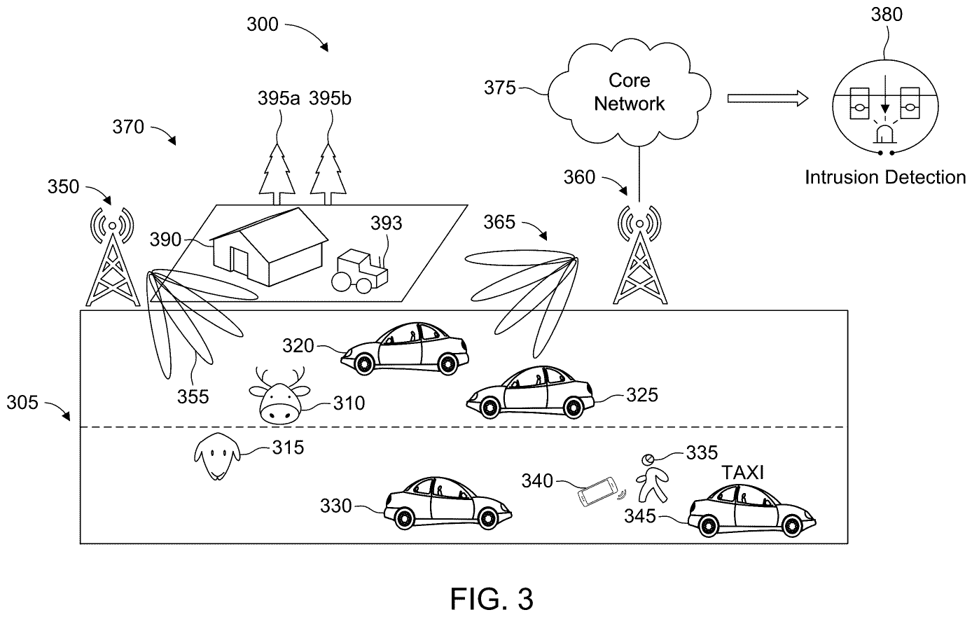

FIG. 3 is a diagram depicting an example of a pedestrian and/or animal intrusion detection, in accordance with certain embodiments.

As shown in FIG. 3, for example, in an outdoor environment 300, pedestrian and/or animal intrusion detection is provided. Environment 300 includes highway 305 and residential property 370 adjacent highway 305. Base station 350 (e.g., which may be the same as base station 114a or 114b) at a first location and base station 360 at a second location emit beams 355 and 365, respectively. Beams 355 and 365 interact with highway 305 and objects 310-345 on highway 305 such as a first animal (e.g., cow) 310, a second animal (e.g., horse) 315, first vehicle 320 traveling in a first direction (right-to-left on the page), second vehicle 325 traveling in a second direction (left-to-right) opposite the first direction, third vehicle 330 traveling in the first direction, pedestrian 335 traveling in the first direction, pedestrian 335 carrying WTRU 340 (e.g., which may be the same as WTRU 102a, 102b, 102c, or 102d), and fourth vehicle 345 traveling in the second direction. Information regarding highway 305, property 370, and objects 310-345 is transmitted by base station 360 (e.g., which may be the same as base station 114a or 114b)) to core network 375 (e.g., which may be the same as CN 106 or 115). Core network 375 transmits the information to intrusion detection application 380. Intrusion detection application 380 is configured to sense, identify, and/or track the objects 310-345, for example, with respect to base stations 350, 360 and/or one or more fixed points along highway 305 and/or property 370, which may include various objects, including a house 390, a farm vehicle 393, and trees 395a, 395b. Intrusion detection application 380 may be configured to differentiate between different types of vehicles (e.g., compact vehicle 325 versus large vehicle 345) or different types of objects (e.g., dog 315 versus human 335) and corresponding locations, directions of movement, velocities, or the like. Another use case for integrated sensing is object detection for the surroundings of a smart home.

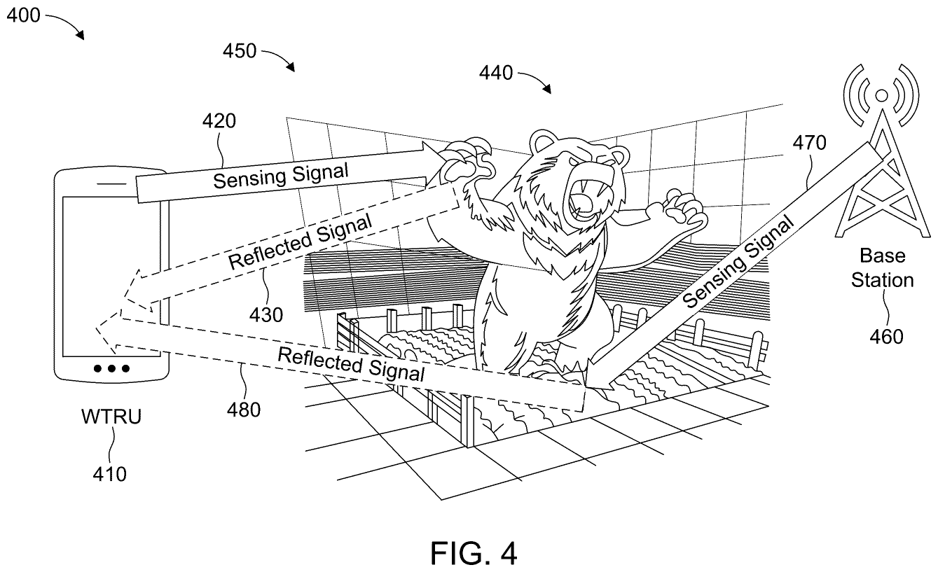

FIG. 4 is a diagram depicting an example of WTRU sensing measurement data collection, in accordance with some embodiments. As shown in FIG. 4, for example, in outdoor environment 400, intruder detection in surroundings 450 of a smart home may be provided. Environment 400 includes WTRU 410 (e.g., which may be the same as WTRU 102a, 102b, 102c, 102d, or 340), intruder (e.g., a bear) 440, and base station 460. WTRU 410 is configured to transmit sensing signal 420, which, in this example, is incident on intruder 440. WTRU 410 is configured to receive reflected signal 430, which, in this example, reflects the sensing signal 420 after incidence with the intruder 440. Base station 460 is configured to transmit sensing signal 470, which, in this example, is incident on surroundings (e.g., the ground) 450. WTRU 410 is configured to receive reflected signal 480, which, in this example, reflects the sensing signal 470 after incidence with surroundings 450.

In the scenarios of FIG. 3 and FIG. 4, a base station (e.g., 350, 360, 460) and/or a WTRU (e.g., 340, 410) can detect the intrusion of an object (e.g., cow 310, vehicle 320, bear 440) into the sensing area of the base station by itself or by collaboration between the WTRU and the base station. For example, the sensing measurement is transferred to the core network 375 and further processed into the sensing result.

In some embodiments, transparent sensing is another use case for integrated sensing where sensing data is captured by a WTRU and communicated so that 5GS is aware of the sensing information. The WTRU may acquire sensing measurements from different 3GPP and non-3GPP devices. 5G core (5GC) may determine various available sensing services by processing collated sensing data.

In some approaches, an integrated sensing service provides object detection and tracking with quality of service (QoS) requirements for a sensing operation. For example, QoS for sensing operations (e.g., sensing QoS) may include accuracy of positioning estimation, accuracy of velocity estimation, range and velocity resolution, latency, confidence level, missed detection error rate, false detection error rate, combinations of the same, or the like. In one example, an unmanned aerial vehicle (UAV) is a service scenario for sensing associated with sensing operations including intrusion detection, tracking and collision avoidance, or the like.

In some integrated sensing and communication service approaches, once a sensing service is requested, a system (e.g., a wireless network) discovers and selects proper sensing entities to perform a sensing operation with one or more requested sensing QoS requirements (e.g., accuracy, granularity, latency, or the like). In some examples, periodic sensing information updates may be required. For example, in weather condition monitoring scenarios such as monitoring rain and snow at a sensing service area, sensing information requires periodic updates by involved sensing entities (e.g., base stations and WTRUs) at the sensing service area.

However, in such integrated sensing and communication service approaches, the Integrated Sensing and Communication (ISAC) system may generate massive amounts of data from the system operated in a dynamic environment with numerous uncertainties. It may be challenging to effectively extract valuable information from massive amounts of sensing data and to do so rapidly.

The massive amounts of data collected during the sensing procedure may contain privacy-sensitive information, such as personally identifiable information (PII), health data, an individual's daily routine, and habits. Considerations of privacy implications and linkage threats in ISAC may need to balance the privacy and utility of the data. In addition, the ISAC system may be subject to component failures, security threats, etc. For instance, one prominent threat in a sensing system is rouge and compromised devices. Thus, security risks of ISAC systems may be considerations in developing corresponding countermeasures to make ISAC secure.

Some such information may be processed locally, and the granularity of the sensing information that should be collected, aggregated, and processed by networking and computing infrastructure may need to be considered so that timely important knowledge may be provided to applications. In some embodiments, a new network function may be defined for coordination of sensing operation as sensing network function (sensing NF). This sensing NF may be a module or other logical entity (e.g., provided as part of or working in concert with the integrated sensing and communications network/service management orchestration [ISANS/SOMS]) and may be collocated with one or more other network entities, such as the network exposure function (NEF). The sensing NF may perform discovery and selection of the ISAC entities when receiving a sensing service request.

In some embodiments, the WTRU may registers its capability for sensing data collection and processing. The WTRU may be installed with the processing agent from the sensing NF such as software or a WTRU functionality. In some embodiments, the processing agent may be installed during the WTRU provision stage later. In some embodiments, the WTRU's capability for collecting sensing measurement data may depend on its onboard sensors or sensors to which it has wired or wireless access, such as via Bluetooth or radio signal. The WTRU's capability for privacy processing may depend on a speed of its processor(s), memory constraints, and other device-specific information. In some embodiments, the WTRU's capability for sensing measurement data collection and/or for privacy processing may be known, or may be retrieved from a database, by the wireless network, and some or all of this information may not be transmitted by the WTRU.

The sensing NF may collaborate with the policy control function/unified data management/unified data repository (PCF/UDM/UDR) of the RAN and formulate the privacy policy to guide the sensing data collection and processing by the sensing entities based on the local privacy regulation, cellular operator's privacy rules, sensing entities'consent, and other information. Details of the privacy policy logistics and derivation are explained in more detail below.

The WTRU may receive processing agent configuration, sensing data collection template, and privacy policy from the sensing NF. The processing agent configuration may include dataset templates that the WTRU is to generate for the Sensing NF. The sensing data collection template may guide the WTRU regarding what sensing data to collect and regarding what data format to use for the collected data. The privacy policy may include privacy processing functions that may need to be applied to the sensing data. The privacy policy may provide guidance for how the processing agent process the raw sensing data into the data to be sent to the destination for final sensing result calculation, such as what types of information to protect in the data collected from different sensing source, and the privacy protecting actions that may be to be carried out to protect these types of information.

The WTRU may collect the sensing measurement data from sensing targets, which may include third generation partnership (3GPP) sensing entities, non-3gpp sensing entities, such as environment sensing entities, based on the data collection templates received from the sensing NF.

The collecting entity, such as the WTRU, may pre-process the collected data before sending it to the network by removing privacy information. In this way, private or other sensitive information collected as sensing information may be appropriately protected and the risk of the collected sensing data posing security threats may be mitigated when it is used to calculate the sensing result for transmission to the network function (NF) of the RAN. The WTRU may process the collected sensing data by anonymizing, removing or obfuscating privacy information, such as PII, to protect user privacy. The WTRU may perform this processing based on the privacy policy and data collection template before it transmits a report on the information to the NF.

The WTRU (or its processing agent) may perform analytics for system behaviors to detect and report significant events, including complicated communication/sensing channels, the surrounding environment, different uncertainties of the system, or anomalies using monitoring data including complicated communication/sensing channels, the surrounding environment and different uncertainties of the system.

The WTRU may send the processed sensing measurement data results via one or more data collection protocols. The processed sensing results may be integrity and confidential protected when sent to the sensing NFs via non-access stratum (NAS) or service-based interface (SBI) with control plane/uplink (CP/UP) to report sensing results. The WTRU may send the results using resource-oriented lightweight information exchange (ROLIE-RFC8322) or using other means. The transmission may be integrity and confidentiality protected.

Depending on the use case, such as object detection, environment detection, tracking, motion detection, etc., a template may be sent to the sensing WTRU with a clear and consistent structure for the collected data, making it easier for the network to process and analyze the collected sensing data.

The WTRU or its processing agent may be provided rules for each sensing task based on the requirements received from the NF as to whether it needs results or sensing data and as to the format thereof. Some sensing data may require pre-processing, which may be, e.g., aggregated samples of angle of arrival (AoA) or time difference of arrival (TDoA) or micro-doppler signatures over time. Similarly, velocity or range values aggregated over some samples may be computed.

In some embodiments, the WTRU may be configured to provide, or may be requested by the NF to provide, only a subset of values for the sensing data, which may also be provided here because micro-doppler may be sometimes unnecessary. The template may explicitly indicate the format and accuracy needed for collected sensing data. The derivation field may offer instructions for transforming raw sensor readings into the required data fields. The privacy_sensitivity field may highlight which data points might require more stringent privacy protection measures as outlined in the privacy policy.

From the sensing NF perspective, after the discovery and selection of the ISAC entities, the sensing NF (e.g. ISANS/SOMS) may collaborate with PCF/UDM/UDR to formulate the sensing data collection template and the privacy policy to guide the sensing data collection and processing by the sensing entities based on the local privacy regulation, operator's privacy rules, sensing entities consent, and other information.

Some fields below may be for sensing results, not sensing data. The fields in the template may include but are not limited to:
template_id: A unique identifier for this data collection template.
description: A brief explanation of the purpose of this data collection.
data_fields: An array of objects, where each object describes a specific data field to be collected. Each data field description may include:
field_name: The name of the data field.
data_type: The expected data type (e.g., “string”, “number”, “boolean”).
format: The specific format in which the data should be provided (e.g., date/time format, units).
accuracy: The required accuracy or precision for the data field.
derivation: A description of how this data field should be derived from the raw sensor data. This may be needed for ensuring consistent pre-processing.
privacy_sensitivity: An indication of the privacy sensitivity of this data field. This may aid in sensing entity prioritize privacy protection measures.

The sensing data collection may happen at the radio access network (RAN) level. Some information in the data_fields may be provided to sensing receivers (RXs) as controlling information for data collection. RAN as the sensing data collection entity may receive a similar data collection template. In some embodiments, only quantized information based on the rules such as accuracy, derivation, format may be collected at RAN node and transferred to sensing NF and other information included in the template may be provided to the sensing NF as a contextual information for deriving sensing result.

The following is an example of aspects of a data collection template that may be extended with more specific data fields relevant to different ISAC use cases, such as hand gesture, picture, video, etc. For example, for environmental sensing, such a data collection template may include fields, such as temperature, humidity, rainfall, and air quality readings.

```
{
  “template_id”: “data-collection-template-v1.0”,
  “description”: “Template for collecting pedestrian movement data for traffic flow
  analysis.”,
  “data_fields”: [
  {
  “field_name”: “timestamp”,
  “data_type”: “string”,
  “format”: “YYYY-MM-DDTHH:mm:ss.SSSZ”,
  “accuracy”: “1 millisecond”,
  “derivation”: “Timestamp of the sensing event recorded by the sensor.”,
  “privacy_sensitivity”: “low”
  },
  {
  “field_name”: “latitude”,
  “data_type”: “number”,
  “format”: “decimal degrees”,
  “accuracy”: “± 5 meters”,
  “derivation”: “Latitude coordinate obtained from GPS or other localization sensor.”,
  “privacy_sensitivity”: “high”
  },
  {
  “field_name”: “longitude”,
  “data_type”: “number”,
  “format”: “decimal degrees”,
  “accuracy”: “± 5 meters”,
  “derivation”: “Longitude coordinate obtained from GPS or other localization sensor.”,
  “privacy_sensitivity”: “high”
  },
  {
  “field_name”: “altitude”,
  “data_type”: “number”,
  “format”: “meters above sea level”,
  “accuracy”: “± 10 meters”,
  “derivation”: “Altitude information from GPS or other altitude sensor (optional).”,
  “privacy_sensitivity”: “medium”
  },
  {
  “field_name”: “speed”,
  “data_type”: “number”,
  “format”: “meters per second”,
  “accuracy”: “± 0.5 m/s”,
  “derivation”: “Calculated as the rate of change of location over time, potentially
smoothed using a Kalman filter.”,
  “privacy_sensitivity”: “medium”
  },
  {
  “field_name”: “direction”,
  “data_type”: “number”,
  “format”: “degrees (0-359, North=0)”,
  “accuracy”: “± 10 degrees”,
  “derivation”: “Calculated as the bearing of movement based on consecutive location
  readings.”,
  “privacy_sensitivity”: “low”
  },
  {
  “field_name”: “sensor_id”,
  “data_type”: “string”,
  “format”: “UUID”,
  “accuracy”: “unique identifier”,
  “derivation”: “Unique identifier of the sensing device.”,
  “privacy_sensitivity”: “low”
  },
  {
  “field_name”: “confidence_level”,
  “data_type”: “number”,
  “format”: “percentage (0.0 - 1.0)”,
  “accuracy”: “N/A”,
  “derivation”: “Confidence score associated with the derived data fields (e.g., speed,
  direction).”,
  “privacy_sensitivity”: “low”
  }
  ]
}
```

Two or more of the data fields of the type shown in this and other examples may be associated together and stored so as to be related. Such associated fields may be processed together based on the privacy policy information. For example, location information may derived based on latitude and longitude data; such location data may be processed and the results of the processing reported only if the confidence level exceeds a threshold confidence level, for example, a 70%-85% or 51%-99% confidence level. By way of further example, speed data may be associated with location information and processed together to determine trajectory. By way of further example, some types of data may be anonymized, obfuscated or removed pursuant to the privacy policy only if associated data is present or meets a predefined threshold. For example, some types of data may be stored with time of day or date data and/or location information, and such data may be deemed to be sensitive and thus subjected to privacy controlling actions, such as anonymization, obfuscation or removal, only if it is collected at certain times of the day or in certain locations (or at time other than certain times of the day or in locations other than in some defined locations). Random/pseudorandom noise may also be added to select data fields to privatize data.

Security policy may be formulated by the NF, such as PCF, to address sensing data privacy in pre-processing based on inputs from: national, state or regional privacy regulations, such as the General Data Protection Regulation (GDPR) and the California Privacy Rights Act (CPRA), operator's privacy rules, and sensing target's privacy setting and user consent. The regional regulations may specify requirements for GDPR compliance, lawful basis for collection, data minimization, storage limitation, and security measures. Operator rules may outline specific requirements set by the network operator, such as minimum anonymization levels and the need for logging data collected or reported. The sensing target's privacy settings may include preferences, such as the need for anonymization, the level of anonymization (k-value), data retention period, purpose limitation, and whether explicit consent is needed for raw data. In some cases, when the target entity ID is known, its privacy setting in unified data management (UDM) and user consent can be checked along with privacy regulation and operator's privacy rules. For a generic target such as in the case of object detection, privacy protection may be based on privacy regulation and operator's rules.

Privacy policy may include preprocessing instructions and reporting requirements. The preprocessing instructions in the policy may provide concrete steps for the sensing entity to follow. These instructions may be tailored specifically for each type of data field.

### Parameters in a Sample Privacy Policy

Privacy policy may specify many types of data, whether a privacy protecting action (e.g., anonymization, obfuscation, etc.) is to be taken on one or more of the types of data, and the privacy protecting actions to take on them. For example, a privacy policy may include:
policy_id: A unique identifier for this specific privacy policy instance.
policy_version: Version number of the policy, allowing for updates and tracking.
effective_date: Timestamp indicating when this policy becomes active.
data_subject_category: The general category of individuals whose data is being sensed (e.g., “Pedestrians”, “Vehicles”).
sensing_target_settings: Reflects the privacy preferences and consent related to the individuals being sensed.
anonymization_required: Boolean indicating if anonymization is mandatory.
pseudonymization_method: The technique to be used for pseudonymization (e.g., “hashing”, “tokenization”).
k_value: The ‘k’ parameter for k-anonymity, ensuring that each released record is indistinguishable from at least k-1 other records.
data_retention_period: How long the pre-processed data can be stored by the sensing entity (ISO 8601 duration format).
purpose_limitation: A list of specific, legitimate purposes for which the sensed data can be used.
explicit_consent_required_for_raw_data: Indicates if explicit consent is needed before transmitting raw, unprocessed data.
operator_rules: Specifies the privacy rules and guidelines set by the network operator. minimum_anonymization_level: The lowest acceptable level of anonymization (e.g., “differential_privacy”, “k-anonymity”).
epsilon_value: Parameter for differential privacy, controlling the privacy-utility trade-off.
logging_enabled: Whether the sensing entity should log its pre-processing activities.
log_retention_period: How long the logs should be kept.
regional_regulations: Details relevant regional privacy regulations such as GDPR.
gdpr_compliance: Boolean indicating if GDPR compliance is required.
lawful_basis_for_processing: The legal basis under GDPR for processing the data.
data_minimization_principles: Whether the principle of collecting only necessary data should be followed.
storage_limitation_principles: Whether the principle of storing data only as long as necessary should be followed.
security_measures: A list of required security measures for data protection.
preprocessing_instructions: A list of specific actions the sensing entity needs to perform on different data fields. Each instruction includes:
   data_field: The name of the data field to be pre-processed (e.g., “location_coordinates”, “speed”).
   action: The pre-processing technique to apply (e.g., “generalize”, “mask”, “anonymize”, “pseudonymize”, “remove”, “obfuscate”).
   parameters: Specific parameters for the chosen action (e.g., spatial resolution for generalization, masking value).
   condition: A logical condition that determines if this preprocessing instruction should be applied. This allows for flexibility based on other policy settings.
reporting_requirements: Specifies whether and how the sensing entity needs to
report on the anonymization/pseudonymization process.
   anonymization_report_required: Boolean indicating if a report is needed.
   report_format: The format for the report (e.g., “JSON”).
   reporting_frequency: How often should the report be sent.

### Actions Specified in the Privacy Policy

One or more actions may be taken to implement data privacy protection. Such actions may be listed below but are not limited to: generalization (sometimes referred to as data obfuscation), masking (sometimes referred to as data removal or data replacement), anonymization, and pseudonymization. Two or more of these data privacy protection measures may be implemented together on the same field or on different fields of the same set of collected data. Two or more of these data privacy protection measures may be prescribed by the policy. Such measures may be techniques used to modify data to reduce or eliminate its identifiability. The privacy processing capabilities (e.g., the supported privacy protection algorithms) may be registered to the sensing NF during the capability registration process. The data collection template information and privacy policy information received by the user equipment may be based on user equipment capability for sensing data collection and for privacy processing.

Generalization is a data privacy technique that replaces specific values with broader, less specific categories or ranges. The goal may be to reduce the granularity of the data while preserving its overall statistical properties and utility for analysis. Some examples of generalization actions that may be taken include: Aggregation—the grouping of individual data points into summary statistics (e.g., average age, total income for a region). Binning/Bucketing—grouping continuous numerical data into ranges (e.g., age 20-29, income $50,000-$75,000). Rounding—reducing the precision of numerical data (e.g., rounding age to the nearest 5 years). Hierarchy-based generalization—using a predefined hierarchy to replace specific values with their higher-level categories (e.g., replacing a specific city with its region, or a specific date with the month or year).

Masking is a data privacy technique that obscures sensitive data by replacing it with artificially generated, but realistically formatted, data. The goal may be to prevent unauthorized access to the original data while allowing the masked data to be used for purposes such as testing, development, or training where the specific values are not critical. For example, a credit card number “1234-5678-9012-3456” may be replaced with “XXXX-XXXX-XXXX-6789” (partial masking) or a completely different but valid-looking number. Some examples of masking actions that may be taken include: Substitution—replacing real values with fictitious but similar data (e.g., replacing real names with fake names, actual addresses with plausible but incorrect addresses). Shuffling—randomly reordering the values within a column to break the link between records while preserving the statistical distribution of that attribute. Randomization—replacing sensitive values with completely random values of the same type and format. Encryption—transforming data into an unreadable format using cryptographic algorithms. Only authorized users with decryption keys can access the original data. Hashing—converting data into a fixed-length string of characters (hash value). This may be a one-way conversion used for verification rather than revealing the original data. Tokenization—replacing sensitive data with non-sensitive placeholder values (tokens). The original data may be stored separately in a secure vault, and the tokens can be detokenized by authorized systems when needed. Nulling/Blanking—replacing sensitive data with null values or empty strings to effectively remove the information.

Anonymization is a data privacy technique that aims to irreversibly remove all direct and indirect identifiers from a dataset, making it impossible to re-identify individuals, even with additional information. Truly anonymized data is no longer considered personal data under many privacy regulations. The goal may be to create a dataset that can be used for research, statistical analysis, and other purposes without any risk of revealing individual identities. The key may be irreversibility. For example, removing names, addresses, and specific dates of birth, and then generalizing ages into broad ranges and locations into larger geographical areas, ensuring that no single record or combination of records can be linked back to a specific person.

Anonymization may entail a variety of techniques, including one or more of the following techniques: removing direct identifiers—deleting one or more attributes that directly identify an individual (e.g., name, social security number, email address, phone number) or portions of such attributes. Generalization—broadening the categories of quasi-identifiers to reduce their uniqueness. Suppression—removing or redacting specific data points that, in combination with other data, could lead to re-identification. Aggregation—combining data in a way that individual records cannot be distinguished. Perturbation—adding noise or random variations to numerical data to obscure individual values while preserving the overall statistical properties. Data Swapping—exchanging values between records for certain attributes to break correlations that could lead to identification. Synthetic Data Generation—creating entirely new datasets that statistically resemble the original data but do not contain any information about real individuals.

Pseudonymization is a data privacy technique that replaces direct identifiers with artificial identifiers (pseudonyms). Unlike anonymization, pseudonymized data may still be linked back to individuals if the pseudonymization key or the additional information linking the pseudonym to the real identity is available. Therefore, pseudonymized data is still considered personal data. The goal may entail reducing the linkability of a dataset with the original identity, thereby decreasing the risk of accidental or malicious disclosure. It may allow data analysis and processing while maintaining a degree of privacy and it may be reversed under specific, controlled conditions. For example, customer names may be replaced with unique customer IDs on invoices. While the sales data may be analyzed based on these IDs, the actual names of the customers may be accessible only through a separate, secured mapping table. Pseudorandomization may entail a variety of techniques, including one or more of the following techniques: replacing names with codes or aliases—substituting names, IDs, addressed, telephone numbers, social security numbers, passport numbers, customer numbers, or contact information with unique, randomly generated identifiers. Tokenization—using non-sensitive tokens to represent sensitive data, where the mapping between the token and the real data is stored separately and securely. Deterministic encryption—encrypting identifiers such that the same identifier results in the same pseudonym, allowing for consistent linking of records belonging to the same individual without revealing the actual identifier. The above-described data privacy protection actions offer different levels of data modification and identifiability reduction, each suitable for various use cases and privacy risk levels. The choice of technique depends on the specific data, the intended purpose of its use, and the applicable legal and regulatory requirements. One or more of the foregoing data privacy techniques may be used together as specified by the privacy policy received and/or based on the aims and requirements of the report to be generated based on the raw data received.

### Example Privacy Policy with Processing Instructions

Provided below is an example privacy policy that may be further customized with more specific requirements, data fields, and pre-processing techniques as needed. The use of conditions within the preprocessing instructions may be used to allow for a more dynamic and context-aware application of privacy measures.

```
{
  “policy_id”: “policy-20250423-1535-woodridge”,
  “policy_version”: “1.0”,
  “effective_date”: “2025-04-23T15:35:00Z”,
  “data_subject_category”: “Pedestrians”,
  “sensing_target_settings”: {
  “anonymization_required”: true,
  “pseudonymization_method”: “k-anonymity”,
  “k_value”: 5,
  “data_retention_period”: “PT24H”,
  “purpose_limitation”: [
  “Traffic flow analysis”,
  “Crowd density estimation”
  ],
  “explicit_consent_required_for_raw_data”: false
  },
    “operator_rules”:{
    “minimum_anonymization_level”: “differential_privacy”,
    “epsilon_value”: 0.5,
    “logging_enabled”: true,
    “log_retention_period”: “P7D”
  },
  “regional_regulations”: {
  “gdpr_compliance”: true,
  “lawful_basis_for_processing”: “Article 6(1)(e) - Public task”,
  “data_minimization_principles”: true,
  “storage_limitation_principles”: true,
  “security_measures”: [
  “Data encryption at rest and in transit”,
  “Access control mechanisms”,
  “Regular security audits”
  ]
  },
    “preprocessing_instructions”: [
  {
  “data_field”: “location_coordinates”,
  “action”: “generalize”,
  “parameters”: {
  “spatial_resolution”: “10 meters”,
  “aggregation_method”: “centroid”
  },
    “condition”: “sensing_target_settings.anonymization_required == true”
  },
  {
    “data_field”: “speed”,
    “action”: “mask”,
    “parameters”: {
    “masking_value”: “N/A”
    },
    “condition”: “sensing_target_settings.explicit_consent_required_for_raw_data ==
    true”
  },
  {
    “data_field”: “direction”,
    “action”: “anonymize”,
    “parameters”: {
    “method”: “k-anonymity”,
    “k_value_reference”: “sensing_target_settings.k_value”
  },
  “condition”: “sensing_target_settings.anonymization_required == true”
  },
  {
    “data_field”: “device_id”,
    “action”: “pseudonymize”,
    “parameters”: {
    “method”: “hashing”,
    “salt”: “random_salt_value_provided_separately”
  }
  },
  {
    “data_field”: “imei”,
    “action”: “remove”,
    “condition”: “true”
  },
  {
    “data_field”: “ip_address”,
    “action”: “remove”,
    “condition”: “regional_regulations.gdpr_compliance == true”
  },
  {
    “data_field”: “user_agent”,
    “action”: “obfuscate”,
    “parameters”: {
    “method”: “replace_with_generic”,
    “generic_value”: “Generic Mobile Device”
  },
    “condition”: “true”
  },
  {
    “data_field”: “proximity_to_other_devices”,
    “action”: “obfuscate”,
    “parameters”: {
    “method”: “add_noise”,
    “noise_level”: 0.2
  },
  “condition”: “sensing_target_settings.anonymization_required == true”
  }
    ],
    “reporting_requirements”: {
    “anonymization_report_required”: true,
    “report_format”: “JSON”,
    “reporting_frequency”: “per_transmission”
  }
}
```

### Sensing Data Collection and Processing

In accordance with some embodiments of the present disclosure, sensing availability evaluation coordinated by the sensing NF is described as follows.

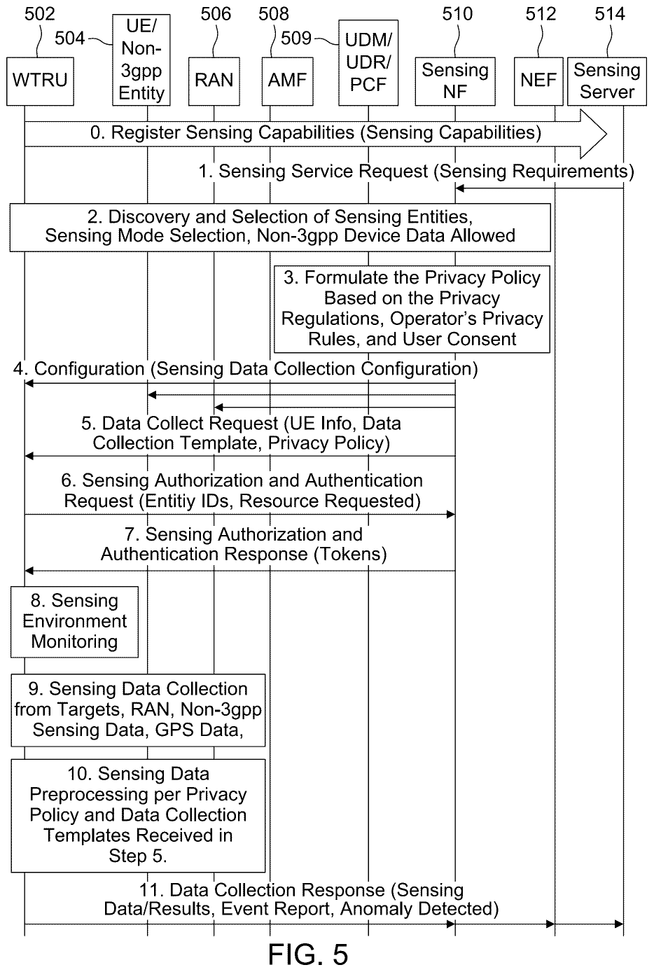

FIG. 5 is a flowchart of an illustrative method 500 for sensing data collection, and processing. As shown in FIG. 5, in some embodiments, the illustrative method 500 includes steps performed by at least one of the following: sensing receivers 502 (e.g., WTRU 102 of FIGS. 1A-1D, WTRU 208 of FIG. 2, WTRU 340 of FIG. 3, WTRU 410 of FIG. 4, or the like); WTRU, non-3gpp Entity 504 (; RAN 506 (e.g., RAN 104 and 113 of FIGS. 1A-1D, RAN 210 of FIG. 2); AMF 508 (e.g., AMF 182a and 182b of FIGS. 1A-1D, AMF 202 of FIG. 2, or the like); UDM/UDR/PCF 509; sensing NF 510; NEF 512; and sensing server 514 combinations of the same; or the like. While FIG. 5 is an example of a method that includes a set of operations (sometimes referred to as steps), not all operations shown may be necessary to carry out the contemplated method. Also, FIG. 5 illustrates a set of operations in a specific order but it will be understood that other sequences of operation are also contemplated and some operations shown separately may be combined. Additional operations not specifically illustrated may also be added as part of the contemplated method. Operations illustrated as being performed by a node or module, may be performed by other nodes or modules, including by nodes or modules not explicitly illustrated in FIG. 5.

At step 0, the WTRU may register its capability for collecting sensing data and processing the collected sensing data. Privacy processing capability such as one or more of the types of privacy protecting actions listed above, including privacy protecting algorithms that are supported, may be include in the registration. In some embodiments, the privacy related rules may be pre-provisioned in sensing entities (for example, WTRUs/NG-RAN nodes). In some embodiments, one or more wireless network functions may access WTRU capabilities for collecting sensing data and processing it, for example, by noting a model number based on the WTRU transmission and retrieving from a database the WTRU capabilities for collecting sensing data and processing the sensing data associated with the model number. In some embodiments, one or more wireless network functions may need to receive from the WTRU only the capability of the WTRU for the collecting of the sensing data or only the capability of the WTRU for the processing of the collected sensing data because the one or more wireless network functions may access other information about the WTRU in a database or may presume that the WTRU of a particular network or the WTRU transmitting on particular frequency band has some set of capabilities for the collecting of the sensing data and/or some set of capabilities for the processing of the collected sensing data.

At step 1, sensing server 514 may send a sensing service request to the sensing NF 510. The parameters of the request may include but are not limited to those in the sensing data collection template discussed above. The parameters of the request may depend on the sensing requirement for the use case.

At step 2, sensing NF 510 may discover sensing TXs and sensing RXs based on a determined sensing mode for the received sensing service request. Sensing NF 510 may select one or more sensing TXs and sensing RXs based on a sensing availability evaluation result.

At step 3, after discovery and selection of the sensing entities (i.e., sensing TXs, sensing RXs), the sensing NF 510 may request an operator's privacy rules, which may include or be based on a variety of considerations, including, for example, regulation requirement, security policy, user consent from NFs, such as the PCF/UDM/UDR 509. One or more of the PCF/UDM/UDR 509 and the sensing NF 510 may formulate the privacy policy to guide the sensing data collection and processing by the sensing entities based on the local privacy regulation, operator's privacy rules, sensing entities consent, and other information.

At step 4, the sensing NF 510 may send configuration information for data collection and processing. The WTRU 502 (as sensing RXs) may receive processing agent configuration, data collection template, and privacy policy from the sensing NF 510. The configuration may include the datasets the WTRU 502 should generate and report to the sensing NF 510. The privacy policy and data collection profile (DCP) may include privacy processing functions that should be applied to the collected sending data. The data collection template may guide the WTRU 502 to determine what data and data format to collect. The privacy policy may guide the way the processing agent of the WTRU 502 processes raw sensing data to yield the data report to be sent to the destination for final sensing result calculation, such as how and what information to protect in the collected from different sensing source.

At step 5, the NF 510 may send data collection requests to all sensing entities along with target WTRU identity if available, data collection template, and privacy policy. In some embodiments, the WTRU 502 may store the configuration information for data collection and processing and when sensing data collection is requested by the NF 510, this configuration step may be omitted. In some embodiments, the WTRU 502 may store the privacy policy for processing and when sensing data collection is requested, this configuration step may be omitted.

At steps 6-7, the sensing entity, such as the WTRU 502 may request authorization tokens for reporting of the collected and processed sensing data from the sensing NF 510 to be used for the authorization to collect data and to report the processed data regarding the one or more sensing targets. The sensing NF 510, at step 7, may respond by transmitting such tokens.

At step 8, the sensing RXs may monitor the environment based on the configuration and the sensing data templates to determine devices and other object about which sensing data is to be collected, and/or from which sensing data is to be requested.

At step 9, the WTRU 502 may collect the data from 3gpp sensing TX, other non-3gpp sensing entities, and environment sensing entities based on the data collection templates received from the integrated sensing and communication network/service management and orchestration (ISANS/SOMS). Based on coordination of sensing NF, sensing TXs and its own sensing, RXs may perform sensing operations. In some embodiments, sensing RXs may send one or more sensing measurement reports directly to the sensing NF 510 or to one or more other sensing processing entities based on coordination by the sensing NF 510.

At step 10, the WTRU 502 may process collected sensing data, for example, by anonymizing and removing or obfuscating privacy information, such as personally identifiable information (PII), based on the privacy policy and data collection template received, so as to protect user privacy before transmission, based on the privacy policy and data collection template, to the wireless network.

In some embodiments, some NF/server (e.g. a pre-processing server collocated with UPF) may perform various privacy/security related processing, before sending the data outside the network. These rules may be provisioned by the session management function (SMF) with the N4 interface (N4)—the communication link between the SMF and UPF, and which the SMF may use to instruct the UPF on how to handle user data. For example, such rules may specify that data belonging to some information in a data flow must be removed, or anonymized, or obfuscated before sending the data outside the network.

The WTRU 502 (or a processing agent) may perform analytics for the system behaviors to detect and report significant events, and/or to report anomalies using monitoring data. Such anomalies may include complicated communication/sensing channels, data traffic conditions or disruptions, factors affecting the surrounding environment, and/or different uncertainties of the system.

At step 11, the WTRU 502 may send the processed sensing results. Any anomaly detected in any data collection protocols. The result and/or other information transmitted may be integrity and confidentially protected when sent to the sensing NFs via non-access stratum (NAS) or (SBI) with control plane/user plane (CP/UP) to report sensing results. In some embodiments, the processed sensing results may be directed to a different network functionality than the network functionality to which the detected anomaly is reported.

In some representative embodiments, based on configuration information received from the wireless network, the WTRU periodically reports its availability as a sensing entity. In some representative embodiments, based on configuration information received from the wireless network, the WTRU reports its availability as a sensing entity when an event is triggered. In some representative embodiments, based on configuration information received from the wireless network, the WTRU reports its availability as a sensing entity as a one-time event upon receiving a request from the sensing NF.

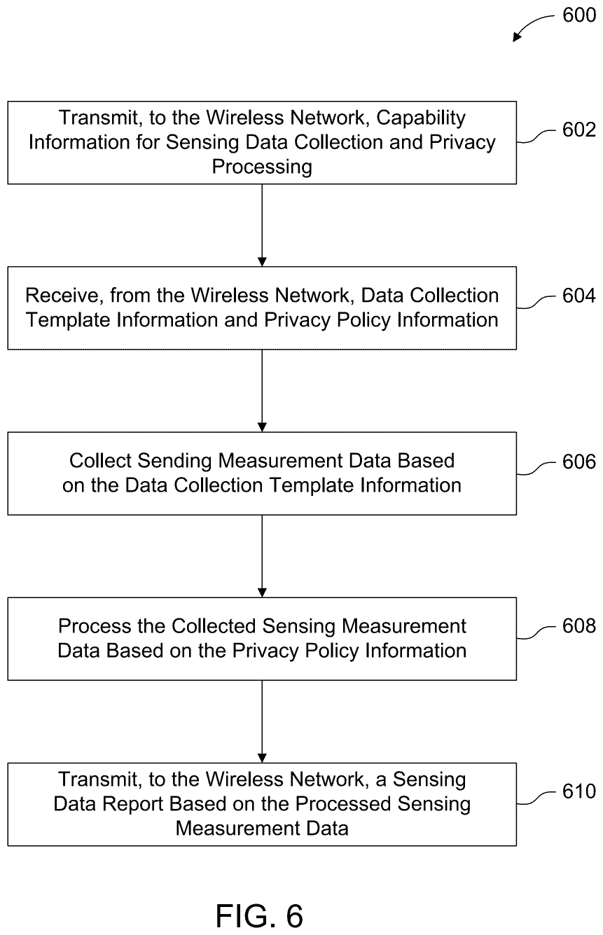

In some representative embodiments, as shown in FIG. 6, a process 600 is performed by a WTRU (e.g., WTRU 102 of FIGS. 1A-1D, sensing entities 502 and 504 of FIG. 5) in connection with a wireless network (e.g., RAN 104 and 113 of FIGS. 1A-D and/or core network 106 and 115 of FIGS. 1A-1D), which may be implemented in communications system 100 illustrated in FIG. 1A-1D. In some embodiments, the wireless network may include and/or be associated with at least one of: a RAN (e.g., RAN 104 and 113 of FIGS. 1A-1D, RAN 506 of FIG. 5); an AMF (e.g., AMF 182a and 182b of FIGS. 1A-1D, AMF 202 of FIG. 2, AMF 508 of FIG. 5); a sensing NF (e.g., sensing NF 510 of FIG. 5); an AF (e.g., AF 512 of FIG. 5); combinations of the same; or the like.

At step 602, the WTRU may transmit, to the wireless network, its capability information for sensing data collection and privacy processing. In some embodiments, step 602 may correspond to, or be performed as part of, step 0 of FIG. 5. The capability information may indicate any of one or more of capability information for sensing measurement data collection and capability information for privacy processing. The privacy policy information may indicate the type (or types) of policy protection actions that are to be used for various types of data in the set of collected data.

At step 604, the WTRU may receive data collection template information and privacy policy information. In some embodiments, step 604 may correspond to, or be performed as part of, step 5 of FIG. 5. The data collection template information may be based on the sensing requirements from a sensing service and the capability information for sensing data collection and the privacy processing. The privacy policy information may be based on sensing requirements from a sensing service, privacy regulation, operator's privacy rules, sensing entity privacy setting, or the capability information for sensing data collection and privacy processing. The privacy policy information may indicate the type (or types) of policy protection actions that are to be used for various types of data in the set of collected data.

At step 606, the WTRU may collect sending measurement data based on the data collection template information. In some embodiments, step 602 may correspond to, or be performed as part of, step 9 of FIG. 5. The WTRU may determine what data to collect and how to organize the collected data based on the received data collection template information. The sensing measurement data may include one or more data types indicated by the data collection template information. The sensing measurement data may include contextual information associated with one or more data fields of the sensing measurement data. Such contextual information may include one or more of a time, a location, or environmental data such as temperature, humidity, or a weather condition. The sensing measurement data may be collected from a device that uses a non-third generation partnership project (non-3GPP) protocol.

At step 608, the WTRU may process the collected sensing measurement data based on the privacy policy information. In some embodiments, step 602 may correspond to, or be performed as part of, step 10 of FIG. 5. This processing may be performed by one or more modules of the WTRU. For example, sensing data collation and organizing may be performed by a module of the WTRU different from the module performing privacy protecting actions such as anonymization, masking and/or obfuscation. Based on the privacy policy information policy protection actions that are to be used for various types of data in the set of collected data may include an obfuscation action on some types of data, and an anonymization action on other types of data. Other such data privacy protection measures may include pseudonymization or masking for the processing of the collected sensing measurement data.

At step 610, the WTRU may transmit, to the wireless network, one or more reports that is has generated based on the processing. In some embodiments, the WTRU may transmit the one or more reports periodically based on the configuration information (e.g., if the configuration information indicates one or more reporting time periods). In some embodiments, the WTRU may transmit the one or more reports in response to an event trigger indicated by the configuration information (e.g., the configuration information may include a trigger condition for the report transmission). For example, the event trigger may be reaching a threshold of a mean or median value, or other statistical value, in the collected or processed data, or the trigger may be an anomaly detection.

The WTRU may also receive configuration information from a sensing NF of the wireless network. For example, the configuration information may indicate at least one of: time period information; reference signals information (e.g., for transmission by sensing transmitters); measurement information (e.g., number of received signals from sensing transmitters, signal strength, delay, or the like); reporting information (e.g., periodic, event-triggered); combinations of the same, or the like.

In some embodiments, the WTRU may detect and prepare a report on anomalies, for example, anomalies in the sending data collected, in the privacy protection processing performed based on the privacy policy received, suspicious activity flagged based on the sending data collected, network issues detected, and the like. In addition, the WTRU may detect channel status information status (e.g., number of received signals from sensing transmitters and/or channel conditions such as signal strength, delay, multipath characteristics, or the like); location information (e.g., geographical location, service area, or the like); frequency information; PLMN information (e.g., a PLMN ID); external WTRU regulatory information (e.g., indicating an area where sensing is not allowed); combinations of the same; or the like. The WTRU may link such information to the report it generates. The WTRU may also link GPU, time, date, ambient temperature, heart rate, skin temperature of the wearer of the WTRU, or a device in communication therewith, to the collected sensing data.

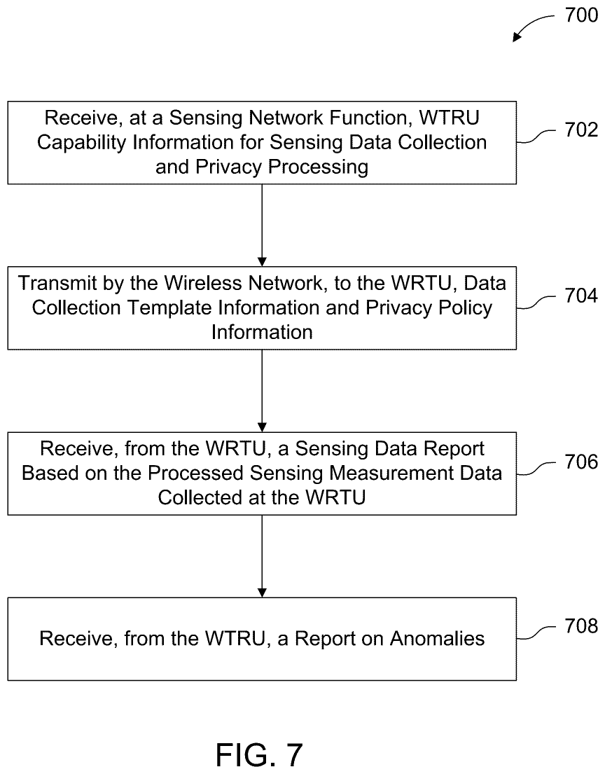

In some representative embodiments, as shown in FIG. 7, a process 700 is performed by a wireless network (e.g., RAN 104 and 113 of FIGS. 1A-1D and/or core network 106 and 115 of FIGS. 1A-1D) in connection with a WTRU (e.g., WTRU 102 of FIGS. 1A-D, sensing entities 502 and 504 of FIG. 5), which may be implemented in communications system 100 illustrated in FIG. 1A-1D. In some embodiments, the wireless network may include and/or be associated with at least one of: sensing receivers (e.g., sensing receivers 502 of FIG. 5); sensing transmitters (e.g., sensing transmitters 504 of FIG. 5); a RAN (e.g., RAN 104 and 113 of FIGS. 1A-1D, RAN 506 of FIG. 5); an AMF (e.g., AMF 182a and 182b of FIGS. 1A-1D, AMF 202 of FIG. 2, AMF 508 of FIG. 5); a sensing NF (e.g., sensing NF 510 of FIG. 5); an AF (e.g., AF 512 of FIG. 5); combinations of the same; or the like.

At step 702, the wireless network may receive, at a sensing NF 510, capability information of one or more WTRUs for sensing data collection and privacy processing. For example, the capability information for sensing data collection and privacy processing may be received in response to a request by the NF 510 transmitted to the WTRU for collecting information. For example, the request to collect information may be sent to the WTRU periodically or in response to some trigger event, such as the detection that the WTRU is on the road or is in communication range of some device or other object of interest. In some embodiments, the WTRU may transmit its capability information for sensing data collection and privacy processing periodically or in response to some external events. For example, the WTRU may detect collect some data that it flags as containing PII.

At step 704, the wireless network may transmit, to the WRTU, data collection template information and privacy policy information. In some embodiments, the wireless network may determine a sensing mode (e.g., GPS, data requests to one or more other nearby devices, ambient temperature data, biometric information, or the like) that the WTRU is to use to collect sensing data.

At step 706, the wireless network may receive, from the WRTU, a sensing data report based on the processed sensing measurement data collected at the WRTU. As discussed, the collection and processing by the WTRU may be based on the data collection template information and based on the privacy policy information that the wireless network had transmitted to the WTRU.

At step 708, the wireless network may receive, from the WTRU, a report regarding any anomalies detected. In addition, the wireless network may receive, from the WTRU, a report regarding statistical patterns, such as averages, medias, standard deviations, and the like, or other patterns, such as times of day or days of week of some occurrences, associations between different types of data, and the like, in the collected sensing data and/or in the processed privacy protected reporting data. In some embodiments, the wireless network may generate a request for further data collection based on the one or more reports it has received from the WTRU and/or from other WTRUs. For example, the wireless network may return to step 802 upon receiving a new request for a new sensing service. Further, for example, the wireless network may return to step 704 based on the received reporting, to request additional sensing data collection, processing and reporting by the WTRU.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “WTRU”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless transmit/receive unit (WTRU), the method comprising:
transmitting, to a wireless network, capability information for sensing measurement data collection and privacy processing;
receiving, from the wireless network, data collection template information and privacy policy information;
collecting sensing measurement data based on the data collection template information;
processing the collected sensing measurement data based on the privacy policy information; and
transmitting, to the wireless network, a sensing data report based on the processed sensing measurement data.

2. The method of claim 1, wherein the sensing measurement data comprises one or more data types indicated by the data collection template information.

3. The method of claim 1, wherein the privacy policy information indicates one or more of an obfuscation action, an anonymization action, a pseudonymization action, or a masking action for the processing of the collected sensing measurement data.

4. The method of claim 1, further comprising:
receiving processing configuration information for a processing agent of the WTRU, wherein the processing configuration information indicates dataset templates that the processing agent of the WTRU is to generate.

5. The method of claim 1, wherein the data collection template information is based on sensing requirements from a sensing service and the capability information.

6. The method of claim 1, wherein the privacy policy information is based on sensing requirements from a sensing service, privacy regulation, operator's privacy rules, sensing entity privacy setting, or the capability information.

7. The method of claim 1, wherein processing the sensing measurement data based on the privacy policy information comprises:
at least one of anonymizing or obfuscating personally identifiable information contained in the collected sensing measurement data.

8. The method of claim 1, wherein the sensing measurement data comprises contextual information associated with one or more data fields of the sensing measurement data.

9. The method of claim 8, wherein the contextual information comprises one or more of a time, a location, or environmental data such as temperature, humidity, or a weather condition.

10. The method of claim 1, wherein the sensing measurement data is collected from a device that uses a non-third generation partnership project (non-3GPP) protocol.

11. A wireless transmit/receive unit (WTRU) comprising:
a processor; and
a transceiver coupled to the processor, wherein the WTRU is configured to:
transmit, to a wireless network, capability information for sensing measurement data collection and privacy processing;
receive, from the wireless network, data collection template information and privacy policy information;
collect sensing measurement data based on the data collection template information;
process the collected sensing measurement data based on the privacy policy information; and
transmit, to the wireless network, a sensing data report based on the processed sensing measurement data.

12. The WTRU of claim 11, wherein the sensing measurement data comprises one or more data types indicated by the data collection template information.

13. The WTRU of claim 11, wherein the privacy policy information indicates one or more of an obfuscation action, an anonymization action, a pseudonymization action, or a masking action for the processing of the collected sensing measurement data.

14. The WTRU of claim 11, wherein the WTRU is further configured to:
receive processing configuration information for a processing agent of the WTRU, wherein the processing configuration information indicates dataset templates that the processing agent of the WTRU is to generate.

15. The WTRU of claim 11, wherein the data collection template information is based on sensing requirements from a sensing service and the capability information.

16. The WTRU of claim 11, wherein the privacy policy information is based on sensing requirements from a sensing service, privacy regulation, operator's privacy rules, sensing entity privacy setting, or the capability information.

17. The WTRU of claim 11, wherein processing the sensing measurement data based on the privacy policy information comprises:
at least one of anonymizing or obfuscating personally identifiable information contained in the collected sensing measurement data.

18. The WTRU of claim 11, wherein the sensing measurement data comprises contextual information associated with one or more data fields of the sensing measurement data.

19. The WTRU of claim 18, wherein the contextual information comprises one or more of a time, a location, or environmental data such as temperature, humidity, or a weather condition.

20. A method performed by a wireless network in communication with a wireless transmit/receive unit (WTRU), the method comprising:
receiving, at a sensing network function, WTRU capability information for sensing data collection and privacy processing;
transmitting, to the WTRU, data collection template information and privacy policy information; and
receiving, from the WTRU, a sensing data report, wherein the sensing data report is determined based on sensing measurement data collected by the WTRU and processed using the data collection template information and the privacy policy information.
